(19) United States
(12) Patent Application Publication
(10) Pub. No.: US 2008/0032142 A1
(43) Pub. Date: Feb. 7, 2008

(54) Light emitting device, method of making the same, and light source device comprising the same

(75) Inventors: Koji Tasumi, Aichi-ken (JP); Yoshinobu Suehiro, Aichi-ken (JP); Seiji Yamaguchi, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Nishikasugai-gun (JP)

(21) Appl. No.: 11/882,599

(22) Filed: Aug. 2, 2007

(30) Foreign Application Priority Data
Aug. 3, 2006 (JP) 2006-212631
Jun. 29, 2007 (JP) 2007-172383

(51) Int. Cl. B32B 9/04; C09K 11/70

(52) U.S. Cl. 428/447; 156/67

(57) ABSTRACT

A light emitting device has a light emitting element mounted on a substrate, a glass member sealing the light emitting element, a transparent member to transmit light emitted from the light emitting device, the transparent member being positioned outside the glass member, and a powdery phosphor attached to an inner surface, an outer surface or both of the inner surface and outer surface of the transparent member.

The present application is based on Japanese patent application No. 2006-212631 and No. 2007-172383, the entire contents of which are incorporated herein by reference.

### BACKGROUND OF THE INVENTION

1. Field of the Invention

This invention relates to a light emitting device and, in particular, to a light emitting device in which a light emitting element on a substrate is sealed with a glass member. Also, this invention relates to a method of making the same and a light source device comprising the same.

2. Description of the Related Art

Conventionally, solid state devices in which a solid state element such as Light Emitting Diode (LED) is sealed with a translucent resin member such as epoxy resin are known. These solid state devices have a problem that the translucent resin deteriorates due to a light emitted from the solid state element. In particular, when III group nitride compound semiconductor light emitting element to emit a light of short wavelength is used as the solid state element, the translucent resin near the element turns yellow due to a high energy light emitted from the element and a heat generated from the element itself, so that light taking out efficiency may be decreased with time.

In order to solve the problem, a solid state device comprising a light emitting element sealed with glass material is proposed by the applicant etc. (for example, refer to Patent Literature 1).

The solid state device is formed by mounting a plurality of LED elements on a substrate comprising ceramics by the flip-chip technology, connecting a plate-like glass to the ceramic substrate by the hot press process, and then cutting together with the substrate by a dicer so as to separate each of the LED elements. In the solid state device, the plate-like glass is cut, so that the glass member is formed in a rectangular parallelepiped shape.

Further, as a light emitting device to emit light comprising a wavelength different from that of light emitted from the solid state device, a wavelength conversion type light emitting device is proposed (for example, refer to Patent Literature 2), the light emitting device comprising a semiconductor assembly covered with a covering member comprising an optically-transparent resin substrate in which phosphor is dispersed almost homogeneously.

Patent Literature 1: JP-A-2006-108621

Patent Literature 2: JP-A-2004-207341

In order to obtain white light in the solid state device described in Patent Literature 1, it is necessary to use phosphor which emits wavelength conversion light when excited by the light emitting wavelength of the LED element. In this case, two cases can be considered, that is, one is that the glass member includes the phosphor, and another is that a translucent resin including the phosphor is disposed outside of the glass member.

However, in the former case, the sealing by using a glass material requires a higher sealing temperature in comparison with the sealing by using a usual translucent resin member, so that the phosphor also becomes high temperature at the glass melting. Therefore, if an organic phosphor or a grassy inorganic phosphor is used, the phosphor may melt into the glass member. Further, if a crystalline inorganic phosphor is used, excitation efficiency may be remarkably decreased.

In the latter case, the phosphor comprises a higher specific gravity than that of the translucent resin, and the phosphor sinks into the translucent resin before the resin is hardened, so that it is difficult to disperse the phosphor into the translucent resin homogeneously, and color heterogeneity easily occurs. Particularly, in the solid state device described in Patent Literature 1, the glass sealing portion is formed in a rectangular parallelepiped shape, so that the size of the glass sealing portion in the height direction on the substrate is increased, the size of the translucent resin disposed so as to cover the glass sealing portion must be also increased in the height direction, and the state that the phosphor is biased on the downside becomes remarkable.

Further, in the light emitting device described in Patent Literature 2, there is a problem that the covering member including the phosphor comprises an even thickness, so that the light emitting device must be increased in size. And, there is a problem that with dependence on the path of light emitted from the light emitting element, difference of light path length from the incoming position to the outgoing position of the covering member occurs, so that the color heterogeneity of light being wavelength-converted by the covering member also occurs. Further, there is a problem that the installation of the covering member including the phosphor in the glass sealed LED takes a lot of trouble, and simultaneously the light taking out efficiency is reduced due to air interfusion between the glass sealed LED and the covering member, and unevenness of light distribution occurs.

### SUMMARY OF THE INVENTION

It is an object of the invention to provide a light emitting device capable of preventing the sealing portion from deteriorating by using glass material for sealing the light emitting device, and simultaneously reducing the color heterogeneity of light obtained, and to provide a light source device comprising the light emitting device.

(1) According to one embodiment of the invention, a light emitting device comprises:

a light emitting element mounted on a substrate;

a glass member sealing the light emitting element;

a transparent member to transmit light emitted from the light emitting device, the transparent member being positioned outside the glass member, and

a powdery phosphor attached to an inner surface, an outer surface or both of the inner surface and outer surface of the transparent member.

In the above embodiment (1), the following modifications and changes can be made.

(i) The glass member is formed in a rectangular parallelepiped shape, and the transparent member is close contact with the glass member.

(ii) The transparent member comprises a resin member, and the substrate comprises a concave portion formed at a contact portion to the resin member.

(iii) The glass member is formed in a rectangular parallelepiped shape, and a space is formed between the glass member and the transparent member.

(iv) The glass member comprises refractive index of not less than 1.6.

(v) The transparent member comprises an adhesive resin member.

(vi) The resin member comprises adhesiveness at room temperature.

(vii) The resin member comprises adhesiveness when heated.

(viii) The transparent member is formed in a lens-like shape to discharge the transmitted light in a predetermined direction.

(ix) A plurality of the transparent members are sequentially formed in a direction of getting away from the light emitting element, and the phosphor is attached to each of the plurality of the transparent members.

(x) A plurality of the light emitting elements are mounted on the substrate, and the transparent member surrounds the plurality of the light emitting elements collectively.

(2) According to another embodiment of the invention, a light emitting device comprises:

a light emitting element mounted on a substrate;

a glass member sealing the light emitting element, and

a powdery phosphor attached to an outer surface of the glass member by electrostatic force.

(3) According to another embodiment of the invention, a light emitting device comprises:

a light emitting element mounted on a substrate;

a glass member sealing the light emitting element;

a transparent member to transmit light emitted from the light emitting device, the transparent member being positioned outside the glass member;

a powdery phosphor attached to an inner surface, an outer surface or both of the inner surface and outer surface of the transparent member, and

a reflection frame disposed on the substrate to surround the light emitting element such that light emitted from the light emitting element is reflected in a predetermined direction.

In the above embodiment (3), the following modifications and changes can be made.

(xi) The transparent member comprises a resin member filled into an inside of the reflection frame, and the phosphor is attached to an outer surface of the resin member.

(xii) The transparent member comprises a plate-like resin member blocking an opening formed by the reflection frame.

(4) According to another embodiment of the invention, a light source device comprises:

the light emitting device according to embodiment (1), and

an optical system into which light emitted from the light emitting device enters, and which discharges the light in a predetermined emission form.

(5) According to another embodiment of the invention, a light source device comprises:

the light emitting device according to embodiment (2), and

an optical system into which light emitted from the light emitting device enters, and which discharges the light in a predetermined emission form.

(6) According to another embodiment of the invention, a light source device comprises:

the light emitting device according to embodiment (3), and

an optical system into which light emitted from the light emitting device enters, and which discharges the light in a predetermined emission form.

(7) According to another embodiment of the invention, a method of making a light emitting device comprising the steps of:

mounting a plurality of light emitting elements on a substrate;

hot-pressing a plate-like glass to the plurality of light emitting elements mounted on the substrate at a predetermined sealing temperature to form a sealed body in which the plurality of light emitting elements are sealed;

segmenting the sealed body into an individual light emitting device, and

attaching a phosphor to a surface of the segmented light emitting device.

In the above embodiment (7), the following modifications and changes can be made.

(xiii) The phosphor attaching step uses the phosphor comprising a lower heat resistance than the predetermined sealing temperature or a melting characteristic at a lower temperature than the predetermined sealing temperature.

(xiv) The phosphor attaching step is conducted such that the phosphor is uniformly attached to a resin member coated on the surface of the light emitting device.

### ADVANTAGES OF THE INVENTION

According to the invention, a light emitting device capable of preventing the sealing portion from deteriorating by using glass material for sealing the light emitting device, and simultaneously reducing color the heterogeneity of light obtained can be provided.

In particular, according to the light emitting device in embodiment (1), the transparent member positioned outside of the glass member, so that the light emitted from the light emitting element is emitted outward after it was transmitted through the transparent member.

At this time, the phosphor attached to the transparent member emits a wavelength conversion light when excited by the light emitting from the light emitting element. And, when the light emitted from the light emitting element and the wavelength conversion light emitted from the phosphor are combined, white light can be obtained.

Further, the powdery phosphor adheres to an inner surface, an outer surface or both of the inner surface and outer surface of the transparent member, so that the phosphor can be evenly distributed on the transparent member. Thus, the light emitting device can be reduced in size. And, the thickness of the phosphor does not change at a specific site on the transparent member, so that the light emitted from the light emitting device can be evenly wavelength-converted without dependence on the path of light.

Further, a trouble that the covering member must be installed individually is eliminated, so that a mass productivity can be enhanced, and decrease in an emission property of the light emitted from the light emitting device is prevented, so that a stable light distribution can be obtained.

### BRIEF DESCRIPTION OF THE DRAWINGS

The preferred embodiments according to the invention will be explained below referring to the drawings, wherein:

FIG. 1 is a cross sectional view schematically showing a light emitting device in a first preferred embodiment according to the invention;

FIG. 2 is a cross sectional view schematically showing a LED element;

FIG. 3 is a cross sectional view schematically showing a LED light emitting body;

FIG. 4 is a cross sectional view schematically showing a LED light emitting body in a condition of being mounted on an aluminum substrate and coated with a resin;

FIG. 5 is a cross sectional view schematically showing a light emitting device in a second preferred embodiment according to the invention;

FIG. 6 is a cross sectional view schematically showing a light emitting device in a third preferred embodiment according to the invention;

FIG. 7 is a cross sectional view schematically showing a light emitting device in a fourth preferred embodiment according to the invention;

FIG. 8 is a cross sectional view schematically showing a light emitting device in a fifth preferred embodiment according to the invention;

FIG. 9 is a cross sectional view schematically showing a light emitting device in a sixth preferred embodiment according to the invention;

FIG. 10 is a cross sectional view schematically showing a LED light emitting body;

FIG. 11 is a cross sectional view schematically showing a light emitting device in a seventh preferred embodiment according to the invention;

FIG. 12 is a cross sectional view schematically showing a light emitting device in a eighth preferred embodiment according to the invention;

FIG. 13 is a cross sectional view schematically showing a light emitting device in a ninth preferred embodiment according to the invention;

FIG. 14 is a cross sectional view schematically showing a light emitting device in a tenth preferred embodiment according to the invention;

FIG. 15 is a cross sectional view schematically showing a light emitting device in a eleventh preferred embodiment according to the invention;

FIG. 16 is a cross sectional view schematically showing a light emitting device in a twelfth preferred embodiment according to the invention;

FIG. 17 is a cross sectional view schematically showing a light emitting device in a thirteenth preferred embodiment according to the invention; and

FIG. 18 is a cross sectional view schematically showing a light source device in a fourteenth preferred embodiment according to the invention.

### DETAILED DESCRIPTION OF THE PREFERRED EMBODIMENTS

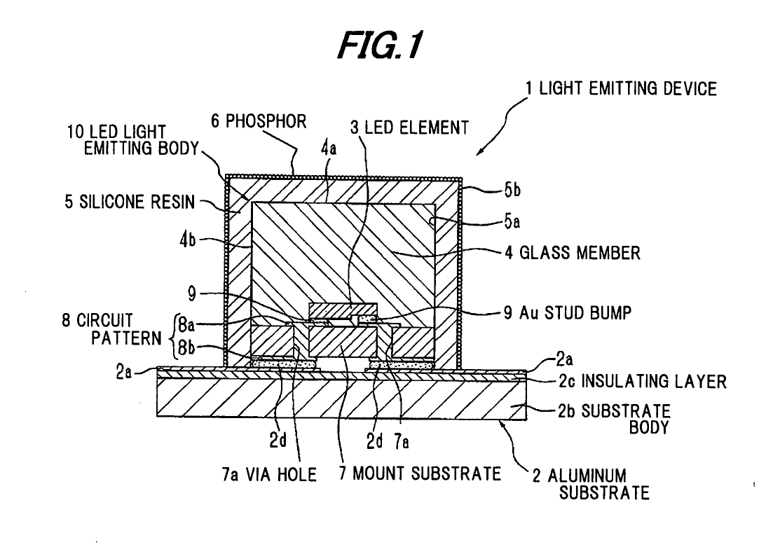

FIGS. 1 to 4 shows a first preferred embodiment according to the invention, and FIG. 1 is a cross sectional view schematically showing a light emitting device.

As shown in FIG. 1, a light emitting device 1 comprises a LED element 3 as a light emitting element mounted on an aluminum base substrate 2 (hereinafter referred to as “aluminum substrate 2”), a glass member 4 sealing the LED element 3, a transparent silicone resin 5 surrounding the opposite side of the LED element 3 to the aluminum substrate 2, and a powdery phosphor 6 overall attached to the opposite surface to the aluminum substrate 2 (outer surface 5b) of the silicone resin 5.

The aluminum substrate 2 comprises a substrate body 2b comprising aluminum, and an insulating layer 2c formed on the substrate body 2b. On the insulating layer 2c constituting a mounting surface of the aluminum substrate 2, a wiring portion 2a to supply an electrical power to the LED element 3 is formed. The wiring portion 2a comprises tungsten (W)-nickel (Ni)-gold (Au).

The LED element 3 comprises a GaN based semiconductor material and emits a blue light. The LED element 3 is a flip-chip type and mounted on a mount substrate 7. In the preferred embodiment, the mount substrate 7 comprises alumina (Al₂O₃) and a circuit pattern 8 comprising tungsten (W)-nickel (Ni)-gold (Au) is formed on the substrate 7. The LED element 3 and the circuit pattern 8 are electrically connected by a Au stud bump 9.

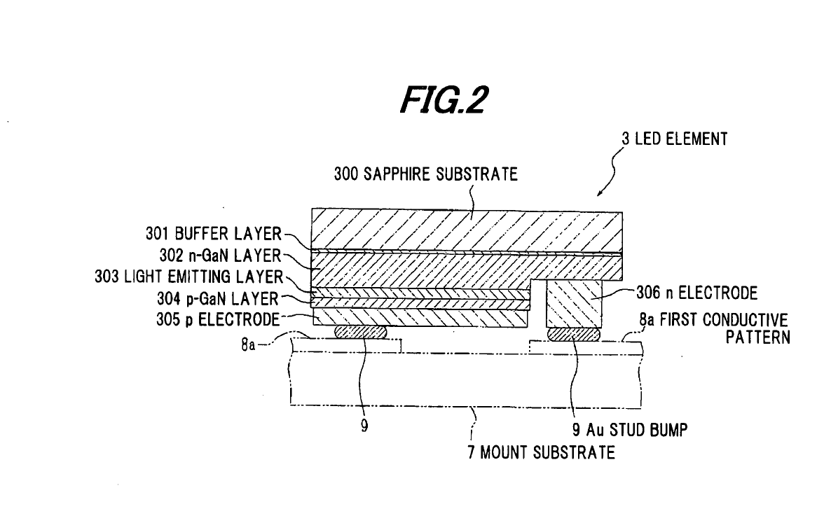

FIG. 2 is a cross sectional view schematically showing a LED element.

As shown in FIG. 2, in particular, the LED element 3 is formed by that a buffer layer 301, an n-type layer 302, a light emitting layer 303, and a p-type layer 304 are respectively grown by a crystal growth method on a surface of a sapphire substrate 300 in order.

Further, the LED element 3 comprises a p-type electrode 305 disposed on a surface of the p-type layer 304, and an n-type electrode 306 disposed on the n-type layer 302 exposed by etching a part of the p-type layer 304 to the n-type layer 302.

The LED element 3 is epitaxially grown at a temperature of not less than 700° C., comprises an allowable temperature limit of not less than 600° C., and is stable against a processing temperature in a sealing process using a low melting thermal adhesive glass described below. The LED element 3 comprises a size of 0.34 mm×0.34 mm×0.09 mm (thickness).

The mount substrate 7 comprises a plurality of via holes 7a passing through in the thickness direction. The via holes 7a is filled with tungsten (W), so as to realize an electrical continuity of the circuit pattern 8 metalized on a front surface and a back surface of the mount substrate 7.

The circuit pattern 8 comprises a first conductive pattern 8a disposed in the mounting side of the LED element 3 on the mount substrate 7, and a second conductive pattern 8b disposed in the back side of the mount substrate 7 and electrically connected to a circuit pattern 2a of the aluminum substrate 2 through a solder 2d.

The glass member 4 comprises for example, B₂O₃—SiO₂—Li₂O—Na₂O—ZnO—Nb₂O₅ based thermal adhesive glass, and is formed in a rectangular shape comprising an upper surface 4a and side surfaces 4b on the mount substrate 7.

Further, the thermal adhesive glass means a glass formed in melt state or softened state by heating, and is different from a glass formed by a sol-gel method. The sol-gel glass changes in volume widely at the forming process to easily generate cracks, so that it is difficult to form a thick film by glass, but the thermal adhesive glass can solve the problem described above.

And, the sol-gel glass generates fine pores therein so that airtightness thereof may be reduced, but the thermal adhesive glass can not cause the problem, so that the LED element 3 can be sealed appropriately.

The side surfaces 4b are formed by that a plate glass attached to the mount substrate 7 by the hot press process are cut by a dicer together with the mount substrate 7. By this, the side surfaces 4b become perpendicular to the mount substrate 7 and, the glass member 4 is formed in a rectangular parallelepiped shape.

Generally, the thermal adhesive glass is processed in several orders of magnitude higher viscosity than a level referred to as a high viscosity in a plastic resin. Further, in a case of glass, even if the temperature exceeds the yielding point (At) by some tens ° C., the viscosity is not decreased up to a level of the general resin sealing. And, if the viscosity of the level at the general resin forming is intended to be obtained, the sealing and forming process become often difficult since the temperature above the crystal growth temperature of the LED element 3 may be required, or the glass may adhere to the mold. Therefore, it is preferable that the process is conducted in the viscosity of not less than 10⁴ poise.

The silicone resin 5 is positioned outside of the glass member 4, and transmits light emitted from the LED element 3. The silicone resin 5 is in close contact with the glass member 4, and is formed so as to cover the upper surface 4a and the lower surfaces 4b of the glass member 4.

As shown in FIG. 1, the silicone resin 5 is formed in a certain thickness, and in a box-like shape in which an inner surface 5a is along an outline of the glass member 4 and an opening of lower surface is blocked by the aluminum substrate 2. The silicone resin 5 comprises adhesiveness at room temperature, and by using the adhesiveness the powdery phosphor 6 is attached to the outer surface 5b thereof.

The phosphor 6 includes a yellow phosphor such as YAG (Yttrium Aluminum Garnet, Y₃Al₅O₁₂: Ce) based phosphor, BOS (Barium ortho-Silicate, Ba₂SiO₄: Eu) based phosphor, and emits a yellow light as a wavelength conversion light when excited by the light emitted from the LED element 3.

As shown in FIG. 1, the phosphor 6 is attached to the surface of the silicone resin 5, so that a layer of the phosphor 6 is formed. In the light emitting device 1, a blue light emitted from the LED element 3 and a yellow light emitted from the phosphor 6 are combined together, so that a white light can be obtained.

A method of making the light emitting device 1 comprising the structure described above will be explained below.

First, a mount substrate 7 comprising via holes 7a is prepared, and W-paste is screen-printed on the front surface and the back surface of the mount substrate 7 according to a circuit pattern 8.

Next, the mount substrate 7 where the W-paste is screen-printed is heat-treated at almost 1000° C. so as to bake the W to the mount substrate 7, and Ni plating and Au plating are conducted on the W, so as to form the circuit pattern 8.

Next, a plurality of LED elements 3 are electrically connected to the first conductive pattern 8a of the mount substrate 7 through the Au stud bumps 9. Further, a plate-shaped thermal adhesive glass is set in parallel to the mount substrate 7 mounting each of the LED elements 3 and the hot press process is conducted in the presence of nitrogen.

It is preferable that the thermal adhesive glass comprises a viscosity of 10⁸ to 10⁹ poise in the hot press process. And, the thermal adhesive glass is attached to the mount substrate 7 through oxides included in them.

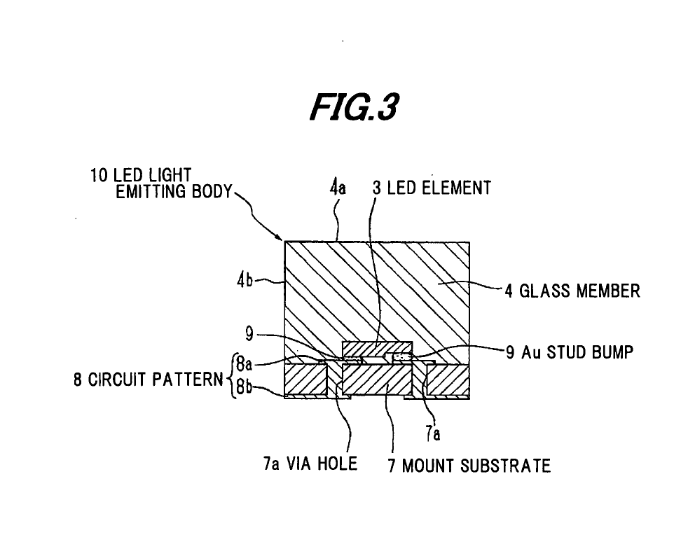

Next, the mount substrate 7 integrated with the thermal adhesive glass is set to a dicer and it is diced so as to separate each of the LED elements 2. By this, a LED light emitting body 10 shown in FIG. 3 can be obtained.

Further, FIG. 3 is a cross sectional view schematically showing a LED light emitting body.

The aluminum substrate 2 comprising the wiring portion 2a formed on the mounting surface of the substrate 2 is prepared, and the LED light emitting body 10 is mounted on the aluminum substrate 2.

In particular, by using a conductive adhesive, the second conductive pattern 8b and the wiring portion 2a of the aluminum substrate 2 are electrically connected, and simultaneously the LED light emitting body 10 is fixed to the aluminum substrate 2.

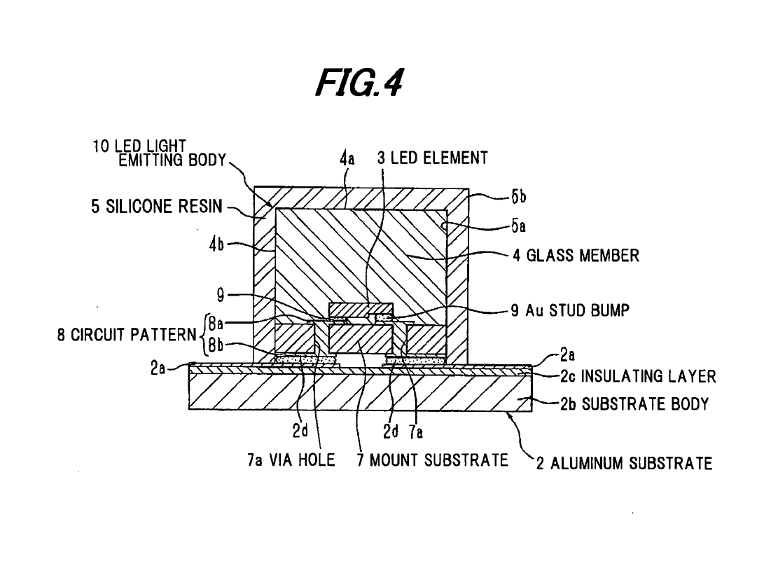

After this, as shown in FIG. 4, a liquid resin is coated on the outer side of the LED light emitting body 10 on the aluminum substrate 2 and hardened, so as to form the silicone resin 5.

FIG. 4 is a cross sectional view schematically showing a LED light emitting body in a condition of being mounted on an aluminum substrate and coated with a resin.

Further, the coating of the silicone resin 5 can be conducted only once, and also can be repeated plural times.

If the resin member coated on the glass member 4 is changed in the adhesiveness or the number of the coating, chromaticity adjustment can be conducted.

Incidentally, the inventors et al. investigate a relationship between the number of coating of the silicone resin 5 and the unevenness of the chromaticity x by an experiment, and it is confirmed that the unevenness of the chromaticity x is controlled, such as when the number of coating is one the unevenness of the chromaticity x is controlled in a range of 0.219 to 0.238, when two it is controlled in a range of 0.286 to 0.299, and when three it is controlled in a range of 0.323 to 0.333. And, by adhering the powdery phosphor 6 evenly to the outer side of the silicone resin 5, the light emitting device 1 shown in FIG. 1 is completed.

According to the light emitting device 1 comprising the structure described above, the silicone resin 5 surrounds the opposite side of the LED element 3 to the aluminum substrate 2, so that the light emitted from the LED element 3 transmits the silicone resin 5 and then emits outward.

At this time, the phosphor 6 attached to the silicone resin 5 is excited by a blue light emitted from the LED element 3, and emits a yellow wavelength conversion light. And, by combining the light emitted from the LED element 3 and the wavelength conversion light emitted from the phosphor 6, a white light can be obtained.

Further, the powdery phosphor 6 is attached to the surface of the silicone resin 5, so that the phosphor can be evenly distributed on the silicone resin 5.

Thus, as shown in FIG. 1, the thickness of the phosphor does not change at a specific site on the silicone resin 5, so that the light emitted from the LED element 3 can be evenly wavelength-converted without dependence on the path of light.

Therefore, the sealing portion can be prevented from deteriorating by using glass material for sealing the LED element 3, and simultaneously the color heterogeneity of light obtained can be reduced.

A structure formed by that a covering body including a phosphor is installed in a light emitting device comprises a size of the light emitting device size plus 2 mm, on the other hand, according to the light emitting device 1 in the preferred embodiment, a structure comprising a size of the light emitting device size plus 0.1 mm can be obtained.

Therefore, the structure of the light emitting device 1 can be kept to almost the same size as the size before the phosphor 6 is coated, so that reduction in a size can be realized in comparison with the structure of installing the covering body.

Particularly, according to the light emitting device 1 in the preferred embodiment, the glass member 4 is formed in a rectangular parallelepiped shape, so that the size of the glass sealing portion in the height direction on the aluminum substrate 2 becomes large.

And, the silicone resin 5 is formed to cover and to be in close contact with the glass member 4, so that also the size of the silicone resin 5 in the height direction becomes large.

At this time, since the phosphor 6 is attached to the surface of the silicone resin 5, it is not caused that the phosphor is nonuniformly concentrated in the lower portion like a conventional device comprising a phosphor included into a resin member, and the color heterogeneity does not occur even if the glass member 4 comprising a rectangular parallelepiped shape and a large size in the height direction is used. Therefore, the device 1 is remarkably advantageous in practical use.

And, even if a sealing is conducted by using glass material, it is not necessary to consider melting of the phosphor and decrease in excitation efficiency, so that degree of freedom in selection of the phosphor is increased, and desired light spectrum can be obtained.

When a LED element was sealed by a glass material including BOS of a crystalline inorganic phosphor in order to observe a deterioration of the phosphor due to the glass sealing, it was confirmed that property deterioration of the phosphor occurred, and desired light spectrum could not be obtained.

When a glass material (manufactured by Sumita Optical Glass Inc.) including BOS based phosphor comprising an excitation wavelength of 470 nm was crushed to a predetermined particle size and was dispersed into a melted phosphate based glass in order to observe a deterioration of the glass, the phosphate based glass and the crushed and mixed glass including the phosphor reacted to each other, as a result, the glass devitrified and even if the LED element 3 was operated to emit a light, the light was not emitted outward.

When a ZnO based glass instead of the phosphate based glass was dispersed similarly in order to observe a deterioration of the glass, it was confirmed that the glass devitrified similarly to the phosphate based glass.

Further, if a methyl based silicone resin is used as the silicone resin 5, a silicone resin less subject to deterioration can be obtained.

Furthermore, the silicone resin 5 is disposed in a site where the glass member 4 mediates, without contact with the LED element 3, so that an influence of light, heat etc. can be reduced and a silicone resin further less subject to deterioration can be obtained.

In a case that the glass member 4 comprises a rectangular parallelepiped shape, if refractive index of the glass is not less than 1/\sqrt{sin 45°}, light confinement in the glass member 4 occurs.

In a case of a glass comprising the refractive index of not less than 1.6, which can increase a light taking out effect than epoxy resin, outward emission efficiency from the glass member 4 to air is reduced due to the light confinement by not less than 20%.

However, layers comprising the silicone resin 5 and the phosphor 6 which sandwiches the silicone resin 5 are disposed outside of the glass member 4, so that the light taking out efficiency from the glass member 4 can be increased due to the silicone resin 5, and by this, the light which reaches the layer of the phosphor 6 becomes scattered light, so that the outward emission efficiency to air can be increased.

Further, if the glass member 4 comprises a rectangular parallelepiped shape, the light confinement is remarkable, but not limiting to the rectangular parallelepiped shape, the higher the refractive index of the glass is, the larger the influence of the refractive index becomes. And, by forming the layers comprising the silicone resin 5 and the phosphor 6, effects of enhancement of the light taking out efficiency and outward emission efficiency can be obtained against the light confinement.

Further, in the first preferred embodiment, a silicon based resin as the resin member was shown, but if it comprises adhesiveness, other resin member, and transparent inorganic paste such as metal chalcogenides can be also used. And, a structure that the phosphor 6 is attached to the outer surface 5b of the silicone resin 5 was shown, but a structure that the phosphor 6 is attached to the inner surface 5a, or both of the inner surface 5a and the outer surface 5b of the silicone resin 5 can be also used.

A device using the LED element 3 of a blue light source as the light emitting element was shown, but a device using a LED element of a violet light source or an ultraviolet light source can be also used. And a light emitting element other than the LED element 3 can be also used.

Further, a red phosphor, a green phosphor, a blue phosphor etc. other than yellow phosphor can be also used as the phosphor 6. As described above, when a LED element of a violet light source or an ultraviolet is used, if the red phosphor, the green phosphor, or the blue phosphor is simultaneously used, a white light can be obtained.

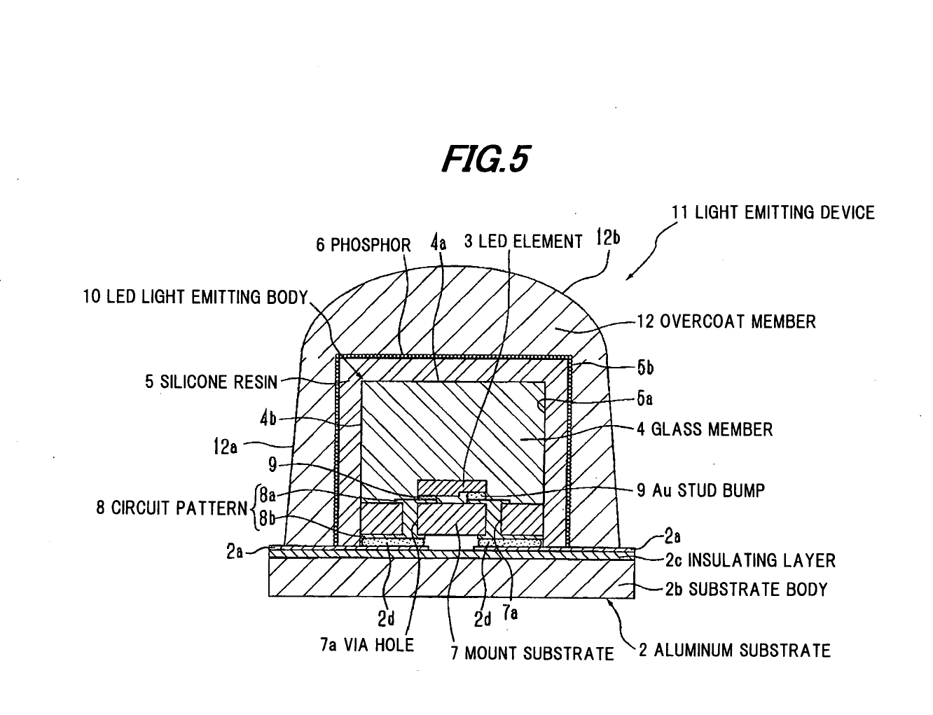

FIG. 5 is a cross sectional view schematically showing a light emitting device in a second preferred embodiment according to the invention. Further, in the explanation of the drawings, the same references are appended to identical or equivalent components, and overlapping explanation is omitted.

As shown in FIG. 5, the light emitting device 11 in the second preferred embodiment comprises an overcoat member 12 covering the phosphor 6 of the light emitting device 1 in the first preferred embodiment. The other structure is equal to that of the first preferred embodiment.

In the preferred embodiment, the overcoat member 12 is made of a silicon based transparent resin, and is formed thicker than the silicone resin 5. The overcoat member 12 has a shrinking diameter portion 12a in which the diameter shrinks bit by bit as the height from the aluminum substrate 2 increases, and a hemispherical portion 12b having a hemispherical shape, continuously formed with the shrinking diameter portion 12a.

As shown in FIG. 5, the shrinking diameter portion 12a and the hemispherical portion 12b are smoothly connected, and they are formed as the curvature factor thereof does not change drastically in the connection portion.

The light emitting device 11 can be made by after making the light emitting device 1 shown in FIG. 1 in the first preferred embodiment, filling the outside of the phosphor 6 with a silicon based resin by using a model, and hardening the resin.

According to the light emitting device 11 comprising the structure described above, the phosphor 6 is covered with the overcoat member 12, so that the phosphor 6 can be tightly attached to the silicone resin 5. By this, the phosphor 6 is not affected by a force from outside directly, so that the phosphor 6 can be prevented from separation from the silicone resin 5.

The phosphor 6 is not exposed to ambient atmosphere directly, so that the phosphor 6 can be prevented from deterioration.

The overcoat member 12 has the hemispherical portion 12b, so that the light taking out efficiency of the light emitted from the LED element 3 can be enhanced.

Further, in the second preferred embodiment, the overcoat member 12 comprising a silicon based resin was shown, but other resin member such as acrylic resin, transparent inorganic paste etc. can be also used for the member 12.

Also in the second preferred embodiment, materials of the resin member, light emission wavelengths of the LED element 3, kinds of the phosphor 6 etc. can be appropriately changed.

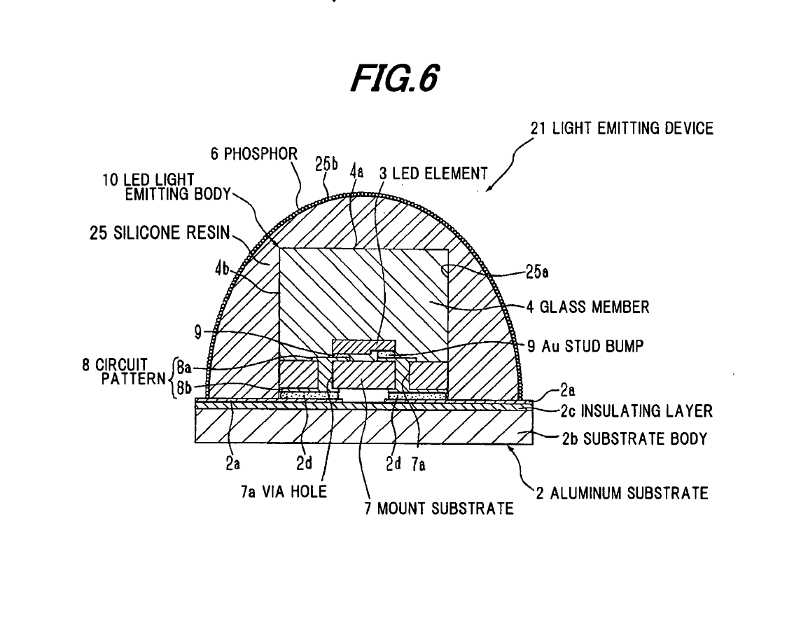

FIG. 6 is a cross sectional view schematically showing a light emitting device in a third preferred embodiment according to the invention. Further, in the explanation of the drawings, the same references are appended to identical or equivalent components, and overlapping explanation is omitted.

As shown in FIG. 6, the light emitting device 21 in the third preferred embodiment is different from the device 1 of the first preferred embodiment in that the silicone resin 25 comprises a different shape. The other structure is equal to that of the first preferred embodiment.

The silicone resin 25 comprises a silicon based resin, and is formed as it covers the upper surface 4a and the side surfaces 4b.

As shown in FIG. 6, the outer surface 25b of the silicone resin 25 is formed in a hemispherical shape being convex upward, and the inner surface 25a is formed along the outline of the glass member 4. That is, the outer surface 25b of the silicone resin 25 is formed in a lens-like shape so as to emit the transmitting light in a predetermined direction.

The silicone resin 25 comprises adhesiveness at room temperature, and the phosphor 6 is attached to the silicone resin 25 by using the adhesiveness. That is, the phosphor 6 is formed as a layer comprising a hemispherical shape along the outer surface 25b of the silicone resin 25.

The light emitting device 21 can be made by after mounting the LED light emitting body 10 on the aluminum substrate 2, filling the outside of the LED light emitting body 10 with a silicon based resin by using a model, hardening the resin, forming the silicone resin 25 comprising a hemispherical shape, and adhering the phosphor 6 to the outer surface 25b of the silicone resin 25.

According to the light emitting device 21 comprising the structure described above, the outer surface 25b of the silicone resin 25 is formed in a hemispherical shape, so that a critical angle in the outer surface to the light emitted in a radial pattern from the LED element 3 can be set to be large, and the light taking out efficiency can be further enhanced.

Further, also in the light emitting device 21 of the third preferred embodiment, the overcoat member 12 to cover the outside of the phosphor 6 can be formed. And, materials of the resin member, light emission wavelengths of the LED element 3, kinds of the phosphor 6 etc. can be appropriately changed.

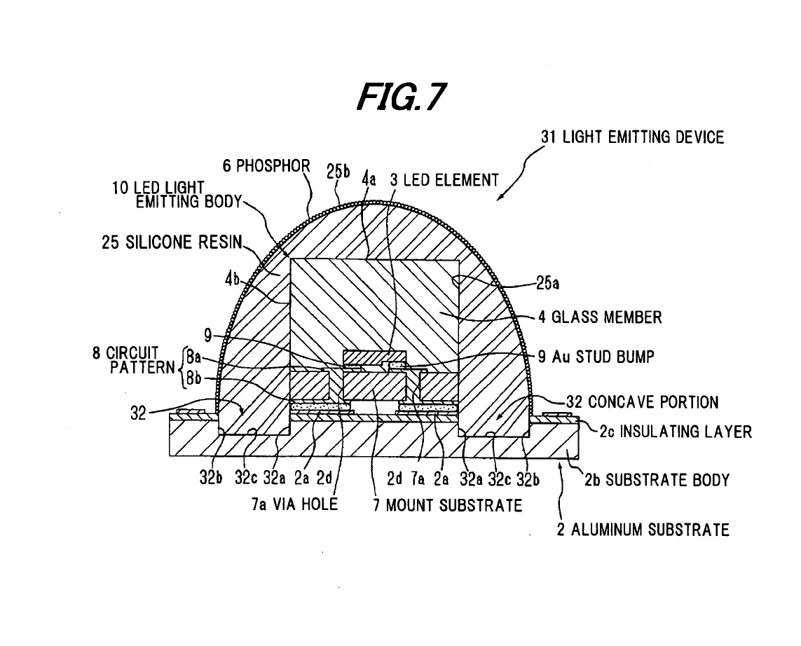

FIG. 7 is a cross sectional view schematically showing a light emitting device in a fourth preferred embodiment according to the invention. Further, in the explanation of the drawings, the same references are appended to identical or equivalent components, and overlapping explanation is omitted.

As shown in FIG. 7, the light emitting device 31 in the fourth preferred embodiment is different from the device 21 of the third preferred embodiment in that a concave portion 32 is formed at a contact portion of the aluminum substrate 2 to the silicone resin 25. The other structure is equal to that of the third preferred embodiment.

As shown in FIG. 7, the concave portion 32 comprises a first side wall 32a formed as almost one surface with the side surface 4b of the glass member 4 and the inner surface 25a of the silicone resin 25, a second side wall 32b formed as almost one surface with the outer surface 25b of the silicone resin 25, and a bottom wall 32c formed in parallel to the mounting surface of the aluminum substrate 2.

Further, in the cross-sectional view of FIG. 7, it appears that the wire portion 2a is cut to pieces by the concave portion 32, but actually, the wire portion 2a is continuously connected at the near side or the depth side of the cross-sectional view shown in FIG. 7 through the inner and outer sides of the concave portion 32, so that power distribution of the LED element 3 can be operated without trouble.

According to the light emitting device 31, when the glass member 4 is coated with a liquid resin at the making process, the concave portion 32 can receive the redundant resin moving to a side of the aluminum substrate 2 by its own weight until the resin is hardened.

The structure comprising the concave portion 32 is advantageous to the cases that for example, the hardening time of the resin is relatively long, and the specific gravity of the resin is relatively large etc. By this, the thickness of the silicone resin 25 in a side of aluminum substrate 2 can be appropriately controlled to be near a constant value.

And, as shown in FIG. 7, if the width of the concave portion 32 is equalized to the thickness of the silicone resin 25, a contact angle between the second side wall 32b of the concave portion 32 and the outer surface of the silicone resin 25 can be reduced as much as possible, so that the silicone resin 25 can be prevented from spreading over the aluminum substrate 2 in a skirt-like shape in the vicinity of an interface between the silicone resin 25 and the aluminum substrate 2.

Further, in the fourth preferred embodiment, the concave portion 32 formed in a cross-sectional shape comprising angles was shown, but the cross-sectional shape of the concave portion 32 can be selected freely, for example, the cross-sectional shape can be a semicircle-like shape and the total shape can be a half pipe-like shape. And, in the fourth preferred embodiment described above, the concave portion 32 is formed so as to surround the glass member 4 in plane view, but a region where the concave portion 32 is formed can be also selected freely.

Further, also in the fourth preferred embodiment, the overcoat member to cover the outside of the phosphor 6 can be formed. And, materials of the resin member, light emission wavelengths of the LED element 3, kinds of the phosphor 6 etc. can be appropriately changed.

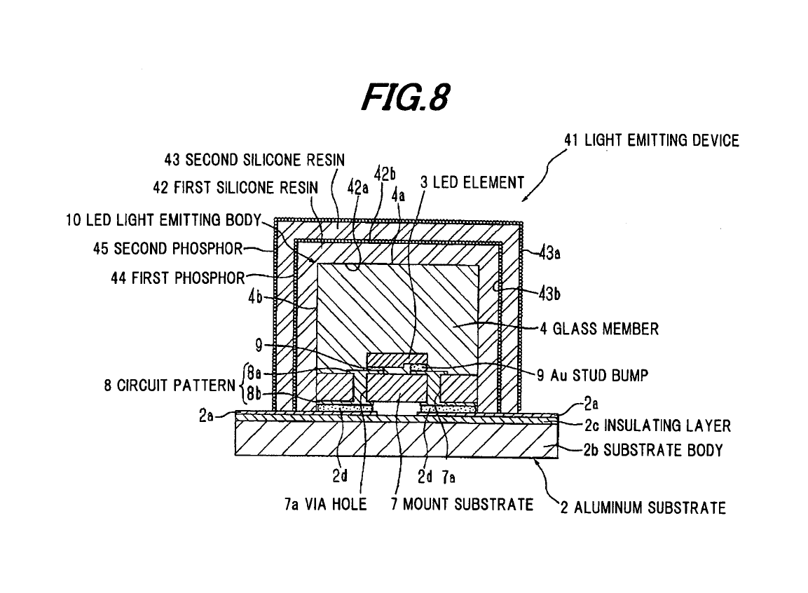

FIG. 8 is a cross sectional view schematically showing a light emitting device in a fifth preferred embodiment according to the invention. Further, in the explanation of the drawings, the same references are appended to identical or equivalent components, and overlapping explanation is omitted.

As shown in FIG. 8, the light emitting device 41 in the fifth preferred embodiment is different from the device 1 of the first preferred embodiment in that a plurality of the silicone resins 42, 43 and the phosphors 44, 45 are formed. The other structure is equal to that of the first preferred embodiment.

The plural silicone resins 42, 43 as the transparent members are formed sequentially in the direction of getting away from a side of the light emitting element 3, and the phosphors 44, 45 are separately attached to each of the silicone resins 42, 43.

The first silicone resin 42 comprises a silicon based resin, and is formed so as to cover the upper surface 4a and the lower surface 4b of the glass member 4.

As shown in FIG. 8, the first silicone resin 42 is formed in a certain thickness and in a box-like shape in which an inner surface 42a is along an outline of the glass member 4 and an opening of lower surface is blocked by the aluminum substrate 2. The first silicone resin 42 comprises adhesiveness, and by using the adhesiveness the powdery first phosphor 44 is attached to the outer surface 42b thereof.

The first phosphor 44 includes a yellow phosphor such as YAG based phosphor, BOS based phosphor, and emits a yellow light as a wavelength conversion light when excited by the light emitted from the LED element 3.

The second silicone resin 43 comprises a silicon based resin, and is formed so as to cover the first phosphor 44. As shown in FIG. 8, the second silicone resin 43 is formed in a certain thickness and in a box-like shape in which an inner surface 43a is along an outline of the first phosphor 44 and an opening of lower surface is blocked by the aluminum substrate 2. The second silicone resin 43 comprises adhesiveness, and by using the adhesiveness the powdery second phosphor 45 is attached to the outer surface 43b thereof.

The second phosphor 45 includes a yellow phosphor such as YAG based phosphor, BOS based phosphor, and emits a yellow light as a wavelength conversion light when excited by the light emitted from the LED element 3.

The making process of the light emitting device 41 is different from that of the first preferred embodiment in that the process comprises the steps of coating the outside of the LED light emitting body 10 on the aluminum substrate 2 with a liquid resin and hardening the resin, so as to form the first silicone resin 42, adhering the first phosphor 44 to the outside of the first silicone resin 42, and coating the outside of the first phosphor 44 with a resin and hardening the resin, so as to form the second silicone resin 43, adhering the second phosphor 45 to the outside of the second silicone resin 43.

In the light emitting device 41 comprising the structure described above, by forming the phosphors 44, 45 in a shape of plural layers, the chromaticity adjustment of the light taken out from the device can be simply and easily conducted.

And, by differentiating each composition of the phosphors 44, 45 from each other, so as to emit each of the wavelength conversion lights comprising peak wavelengths different from each other, a white light comprising broad spectrum characteristics can be obtained.

Further, also in the fifth preferred embodiment, the concave portion can be formed at a contact portion of the aluminum substrate 2 to the silicone resin members 42, 43. And, the overcoat member to cover the outside of the phosphor 6 can be also formed. Further, materials of the resin member, light emission wavelengths of the LED element 3, kinds of the phosphor 6 etc. can be appropriately changed.

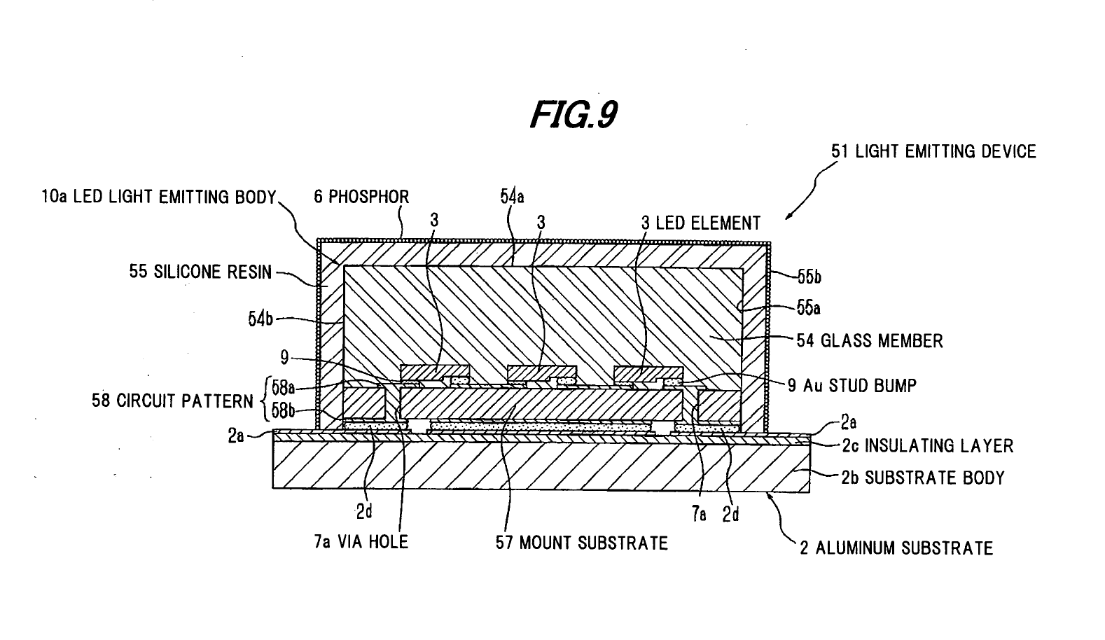

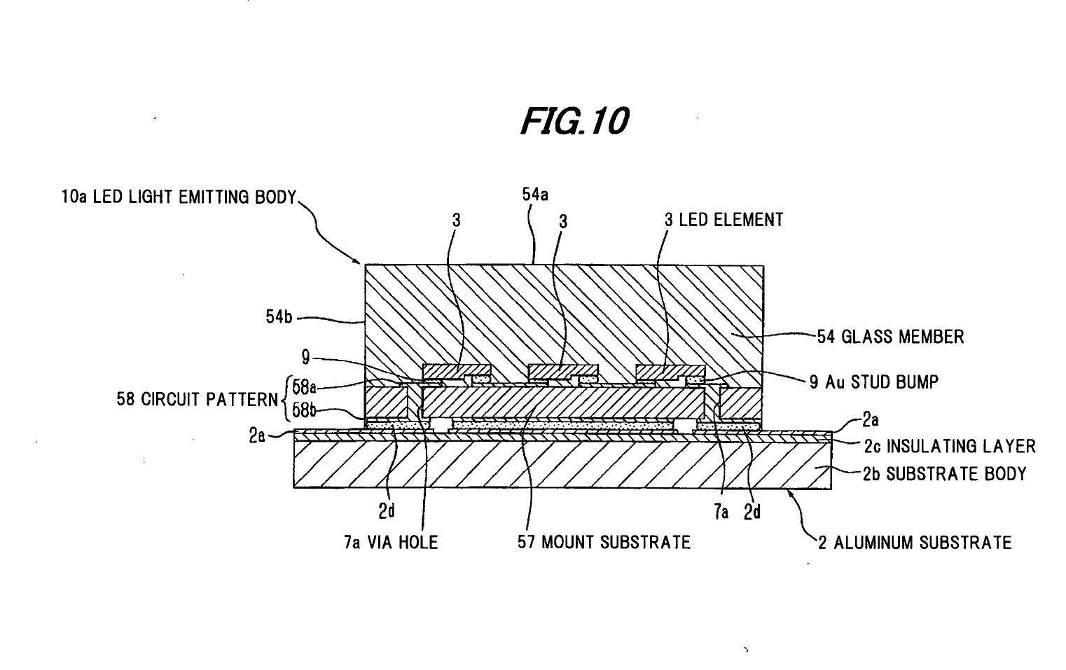

FIGS. 9, 10 are a cross sectional view schematically showing a sixth preferred embodiment according to the invention. FIG. 9 is a cross sectional view schematically showing a light emitting device. Further, in the explanation of the drawings, the same references are appended to identical or equivalent components, and overlapping explanation is omitted.

As shown in FIG. 9, the light emitting device 51 in the sixth preferred embodiment is different from the device 1 of the first preferred embodiment in that a plurality of LED element 3 are formed on the aluminum substrate 2 and the silicone resin 55 surrounds each of the LED elements 3 collectively.

Each of the LED elements 3 is mounted on the mount substrate 57 in an arrangement of 3 pieces×3 pieces in length and width and 9 pieces in total through the Au stud bumps 9 in order that distance between each others in length and width becomes 600 μm respectively.

In the preferred embodiment, the glass member 54 is continuously formed in length and width corresponding to 9 pieces of the LED element 3, so as to seal 9 pieces of the LED element 3 collectively, without sealing each of the LED elements 3 separately.

Further, a size in the width direction of the glass member 54 is 2.7 mm, and a size in the thickness direction is 1.0 mm.

And also, in the preferred embodiment, the circuit pattern 58 comprises a first conductive pattern 58a disposed in the mounting side of the LED element 3 on the mount substrate 7, and a second conductive pattern 58b disposed in the back side of the mount substrate 7. And, the first conductive pattern 58a connects 3 pieces of the LED element 3 in the width direction in series.

The silicone resin 55 is formed so as to cover the upper surface 54a and the side surfaces 54b of the glass member 54.

As shown in FIG. 9, the silicone resin 55 is formed in a certain thickness, and in a box-like shape in which an inner surface 55a is along an outline of the glass member 54 and an opening of lower surface is blocked by the aluminum substrate 2.

The silicone resin 55 comprises adhesiveness, and by using the adhesiveness the powdery phosphor 6 is attached to the outer surface 55b thereof.

In the light emitting device 51, the mount substrate 57 integrated with the thermal adhesive glass is cut by a dicer so as to separate every 9 pieces of the LED element 3 as a unit.

FIG. 10 is a cross sectional view schematically showing a LED light emitting body.

According to the light emitting device 51 in the preferred embodiment, while the glass member 54 is formed relatively longer in the parallel direction to the aluminum substrate 2 with comparison with the thickness direction of the aluminum substrate 2, the layer of the phosphor 6 comprising a certain thickness is formed, so that the color heterogeneity can be accurately prevented.

In a sealing portion formed relatively longer in the parallel direction to the aluminum substrate 2, there is a problem that if the phosphor 6 is included into the sealing portion, difference of light path length between a light emitted laterally from the sealing portion and a light emitted upward from the sealing portion is increased, so that if the blue LED element 3 and a yellow phosphor such as YAG are combined, coloring is changed.

There is a problem that if an ultraviolet light and a red, green, and blue phosphor are combined, when the phosphor volume is excessive, loss due to the light confinement occurs, and when the phosphor volume is inadequate, loss due to leaked light occurs, so that the light emission efficiency is reduced.

According to the light emitting device 51 in the preferred embodiment, the wavelength conversion light is emitted through the phosphor 6 comprising a certain thickness whether an upper side or a lateral side of the glass member 54, so that the conventional problems can be solved.

Further, unless the sealing member is formed in a hemispherical shape centering on the LED element 3 which is one piece, the problems described above occurs. If the ratio of a size in the width direction of the glass member 54 to a size in the height direction is beyond a range of 2.0±0.5, or even if within the range, evident influence occurs if a plurality of the LED elements 3 are arranged in the lateral direction, but the preferred embodiment can solve the problems.

Further, also in the light emitting device 51 in the sixth preferred embodiment, the concave portion can be formed at a contact portion of the aluminum substrate 2 to the silicone resin member 55. The overcoat member to cover the outside of the phosphor 6 can be also formed. Further, materials of the resin member, light emission wavelengths of the LED element 3, kinds of the phosphor 6 etc. can be appropriately changed.

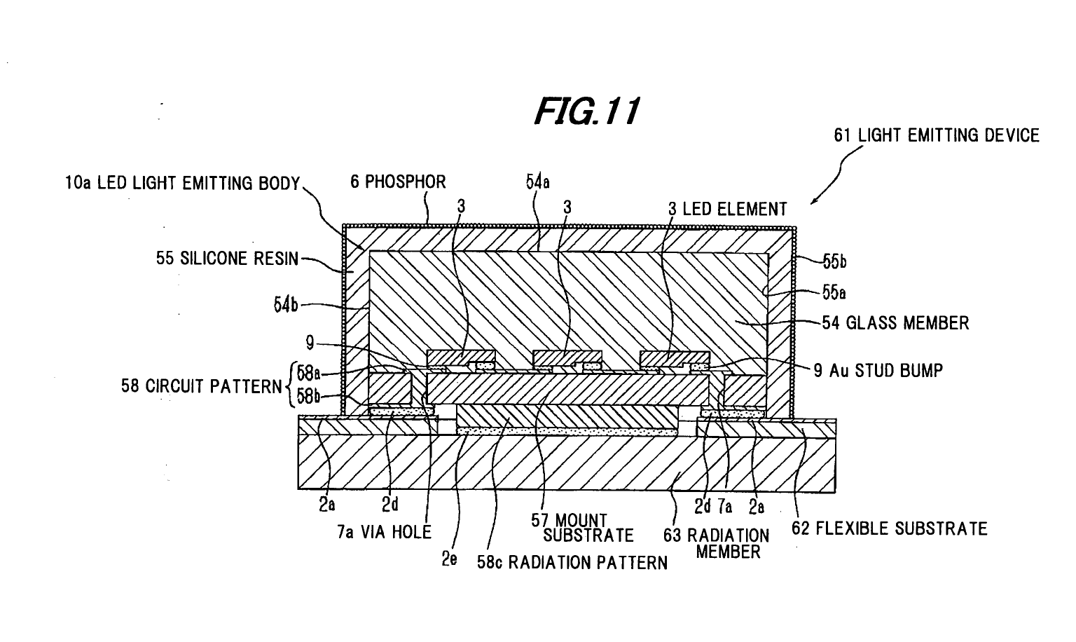

FIG. 11 is a cross sectional view schematically showing a light emitting device in a seventh preferred embodiment according to the invention. Further, in the explanation of the drawings, the same references are appended to identical or equivalent components, and overlapping explanation is omitted.

As shown in FIG. 11, the light emitting device 61 in the seventh preferred embodiment is different from the device 51 of the sixth preferred embodiment in that the LED element 3 is mounted on a flexible substrate 62 comprising polyimide resin, and a radiation member 63 comprising copper slag is mounted on the surface of the flexible substrate 62 opposite to the surface mounting the LED element 3.

As shown in FIG. 11, a radiation pattern 58c is formed on the mount substrate 57 separately from the circuit pattern 58b. The radiation pattern 58c is formed so as to project to a side of the flexible substrate 62 further than the circuit pattern 58b, and is connected to the radiation member 63 through holes formed in the flexible substrate 62 by solder 2e.

In the light emitting device 61, a plurality of the LED elements 3 are disposed tightly so as to increase the heat generation value, and a resin substrate inferior to heat transfer performance than ceramics etc. is used, so that the device 61 comprises a disadvantageous structure in the heat transfer performance.

However, by installing the radiation member 63, heat generated at each of the LED elements 3 is radiated, so that a certain heat transfer performance can be ensured, and the device 61 is remarkably advantageous in practical use.

Further, in the seventh preferred embodiment, a structure that the radiation member 63 is mounted on the flexible substrate 62 comprising polyimide resin was shown, but a substrate comprising for example, other resin such as glass epoxy resin, ceramics such as alumina, metal such as copper can be also used.

The radiation member 63 comprising copper slag was shown, if it comprises good heat conductivity, other material can be also used. It is preferable that metal comprising the heat conductivity of not less than 100 W/mk is used as the radiation member 63.

Further, also in the seventh preferred embodiment, the concave portion can be formed at a contact portion of the flexible substrate 62 to the silicone resin member 55. And, the overcoat member to cover the outside of the phosphor 6 can be also formed. Further, materials of the resin member, light emission wavelengths of the LED element 3, kinds of the phosphor 6 etc. can be appropriately changed.

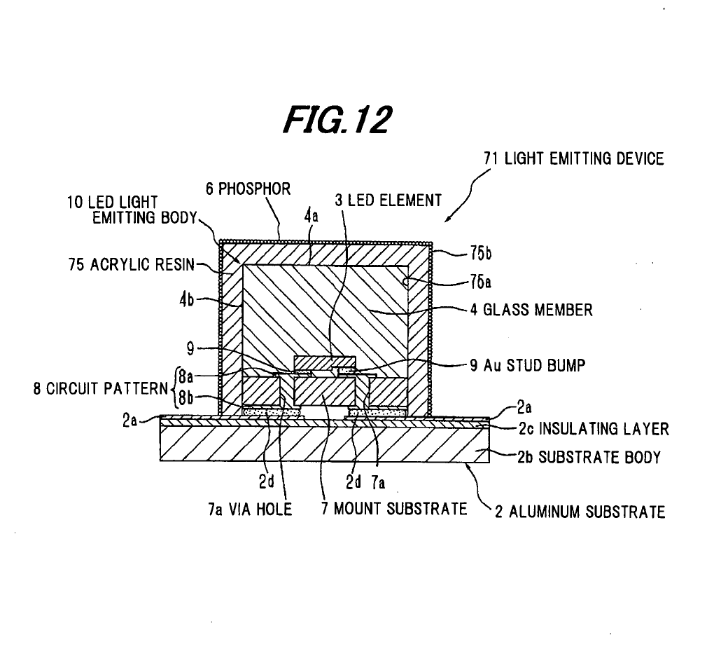

FIG. 12 is a cross sectional view schematically showing a light emitting device in a eighth preferred embodiment according to the invention. Further, in the explanation of the drawings, the same references are appended to identical or equivalent components, and overlapping explanation is omitted.

As shown in FIG. 12, the light emitting device 71 in the eighth preferred embodiment is different from the device 1 of the first preferred embodiment in that the resin member comprises different material. The other structure is equal to that of the first preferred embodiment.

In the preferred embodiment, acrylic resin 75 is used as the resin member to cover the glass member 4. The acrylic resin 75 comprises thermal plasticity, and when heated it is softened and becomes adherent. That is, the acrylic resin 75 does not comprise adhesiveness of the extent that powdery body can be adhered at room temperature.

Also, in the preferred embodiment, the acrylic resin 75 is formed in a certain thickness, and in a box-like shape in which an inner surface 75a is along an outline of the glass member 4 and an opening of lower surface is blocked by the aluminum substrate 2. The silicone resin 5 comprises adhesiveness, and by using the adhesiveness the powdery phosphor 6 is attached to the outer surface 75b thereof.

The light emitting device 71 is made by that in a condition that the acrylic resin 75 is heated, the resin with which the LED light emitting body 10 is coated, the phosphor 6 is attached to the outer surface 75b of the acrylic resin 75.

In the light emitting device 71, when the acrylic resin 75 is cooled to room temperature, the acrylic resin 75 is hardened, so that the phosphor 6 adheres to the acrylic resin 75 tightly, and adhesiveness of the phosphor 6 to the acrylic resin 75 becomes good.

And adhesiveness of the acrylic resin 75 is decreased at room temperature, so that after the making process foreign material such as grit and dust may not attach to the acrylic resin 75.

Further, also in the eighth preferred embodiment, the overcoat member to cover the outside of the phosphor 6 can be also formed. Further, materials of the resin member, light emission wavelengths of the LED element 3, kinds of the phosphor 6 etc. can be appropriately changed.

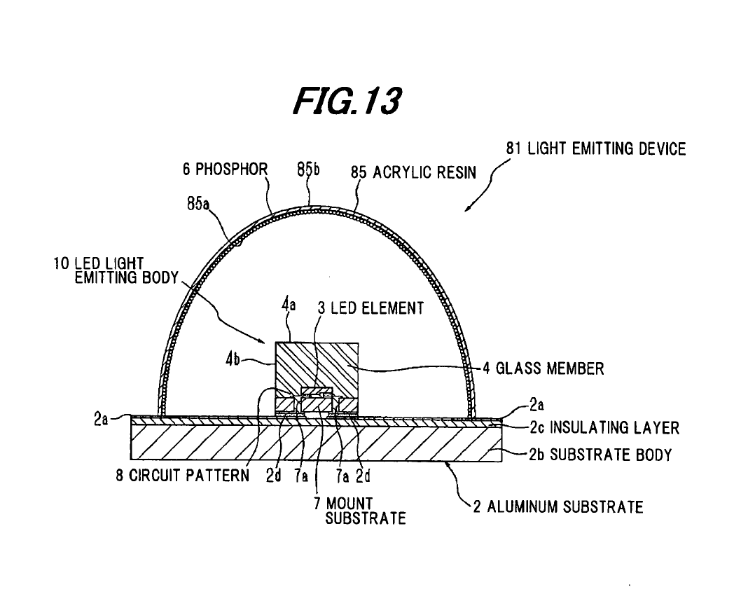

FIG. 13 is a cross sectional view schematically showing a light emitting device in a ninth preferred embodiment according to the invention. Further, in the explanation of the drawings, the same references are appended to identical or equivalent components, and overlapping explanation is omitted.

As shown in FIG. 13, the light emitting device 81 in the ninth preferred embodiment is different from the device 71 of the eighth preferred embodiment in that shape of the acrylic resin 75 is different. The other structure is equal to that of the eighth preferred embodiment.

In the preferred embodiment, the acrylic resin 85 is disposed apart from the glass member 4, and is formed in a hemispherical shape surrounding the LED element 3 in the side opposite to the aluminum substrate 2. That is, a space is formed between the glass member 4 and the acrylic resin 85.

The acrylic resin 85 is formed in a certain thickness, and the phosphor 6 is attached to the inner surface 85a.

When the light emitting device 81 is made, preliminarily, in a condition that the acrylic resin 85 of the hemispherical shape is heated, the phosphor 6 is attached to the inner surface 85a. And the acrylic resin 85 attached with the phosphor 6 is tightly attached to the aluminum substrate 2 mounting the LED light emitting body 10 by using an adhesive etc., so as to make the light emitting device 81.

According to the light emitting device 81 in the preferred embodiment, the phosphor 6 is attached to the inner surface of the acrylic resin 85, so that the phosphor 6 can be effectively protected. And, the acrylic resin 85 is formed in a hemispherical shape, so that the light taking out efficiency can be enhanced.

Further, in the light emitting device 81 in the ninth preferred embodiment, a structure that the phosphor 6 is attached to the inner surface 85a of the acrylic resin 85 was shown, but a structure that the phosphor 6 is attached to the outer surface 85b, or both of the inner surface 85a and the outer surface 85b can also used.

The acrylic resin 85 comprising a hemispherical shape was shown, shape of the acrylic resin 85 can be freely selected.

Further, also in the ninth preferred embodiment, materials of the resin member, light emission wavelengths of the LED element 3, kinds of the phosphor 6 etc. can be appropriately changed.

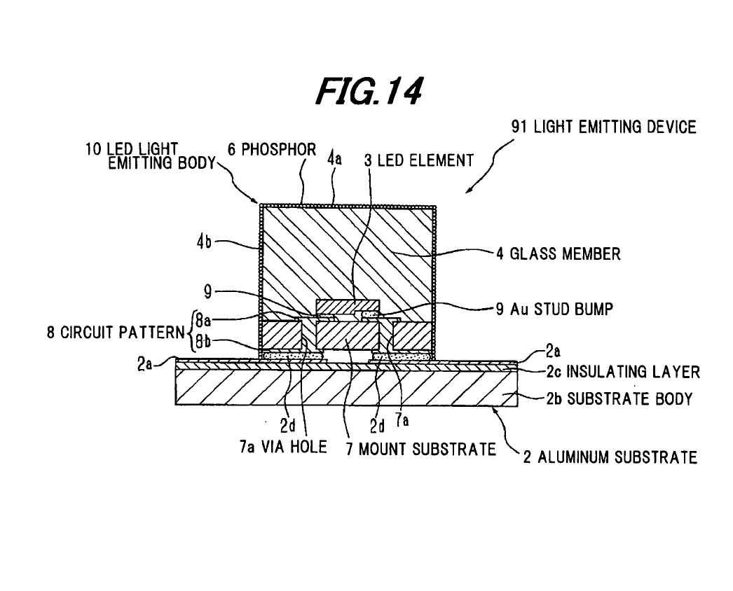

FIG. 14 is a cross sectional view schematically showing a light emitting device in a tenth preferred embodiment according to the invention. Further, in the explanation of the drawings, the same references are appended to identical or equivalent components, and overlapping explanation is omitted.

As shown in FIG. 14, the light emitting device 91 in the tenth preferred embodiment is different from the devices of the other preferred embodiments in that the phosphor 6 is attached to the glass member 4 without forming the resin member such as the silicone resin 5, 25, 42, 43, 55, the acrylic resin 75, 85.

The light emitting device 91 in the preferred embodiment is made by that after the LED light emitting body 10 is made in the same procedure as that of the first preferred embodiment, the phosphor 6 is attached to the glass member 4 by using electrostatic force.

For example, the glass member 4 is used as a positive electrode and outside coating apparatus is used as negative electrode, high voltage is applied to the electrodes so as to form electrostatic field between both of the electrodes, and the phosphor 6 is charged negatively so as to stick to the glass member 4 of an opposite electrode.

The light emitting device 91 comprising the structure described above can omit the resin member, so that the production cost can be reduced. And, the phosphor 6 is attached to the glass member 4 being charged, so that the phosphor 6 does not enter a site other than the glass member 4, and the device 91 is remarkably advantageous in practical use.

Further, also in the tenth preferred embodiment, the overcoat member to cover the outside of the phosphor 6 can be also formed. Further, materials of the resin member, light emission wavelengths of the LED element 3, kinds of the phosphor 6 etc. can be appropriately changed.

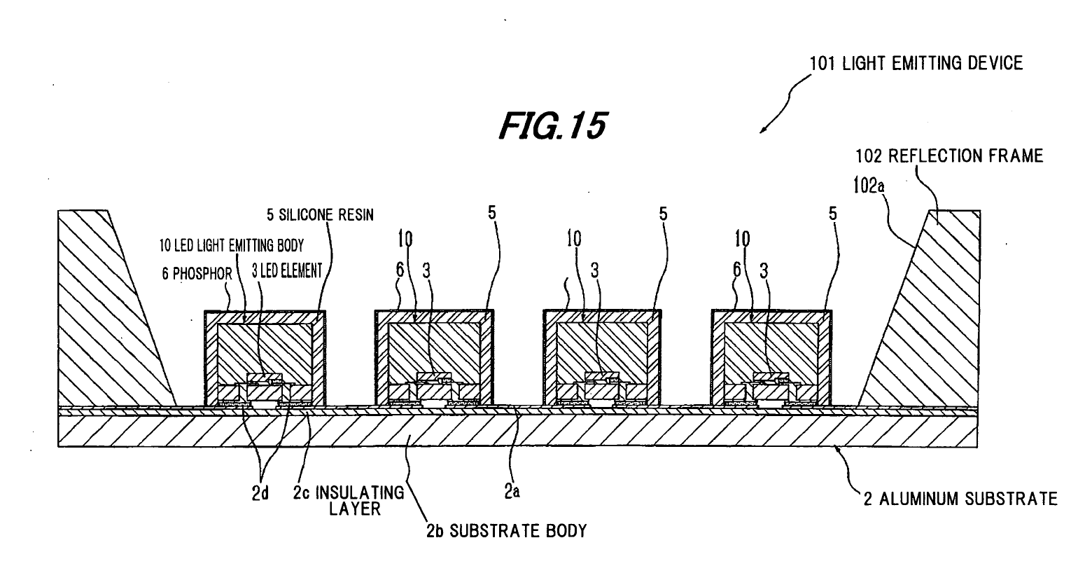

FIG. 15 is a cross sectional view schematically showing a light emitting device in a eleventh preferred embodiment according to the invention. Further, in the explanation of the drawings, the same references are appended to identical or equivalent components, and overlapping explanation is omitted.

As shown in FIG. 15, the light emitting device 101 in the eleventh preferred embodiment is different from the device 1 of the first preferred embodiment in that a reflection frame 102 is further formed in order to reflect the light emitted from the LED element 3 upward. The plural LED elements 3 are mounted.

The other structure is equal to that of the first preferred embodiment.

As shown in FIG. 15, the light emitting device 101 comprises the LED light emitting bodies 10 covered with the silicone resin 5 to which the phosphor 6 is adhered, the bodies 10 being arranged on the aluminum substrate 2, and the device 101 is operable to reflect the lights emitted from a plurality of the LED elements 3 upward by the reflection frame 102 positioned at the most outside in sectional view.

In the preferred embodiment, each of the LED elements 3 is arranged in a form of 4 pieces×4 pieces in length and width, and 16 pieces in total of the LED element 3 are mounted on the aluminum substrate 2.

The reflection frame 102 is made of aluminum, and is formed in a quadrangular shape surrounding each side of the LED elements 3. Further, material of the reflection frame 102 includes copper and steel other than aluminum material, the copper and steel material in which silver is deposited on or white melamine is baking-finished on the inner wall thereof. And a white resin can be also uses as the reflection frame 102.

The reflection frame 102 comprises a reflection mirror 102a in the inner wall, the mirror 102a being formed as the inclination angle becomes 45° to 60° to the aluminum substrate 2. In the preferred embodiment, the reflection frame 102 has light reflection coefficient of not less than 90%.

In the light emitting device 101 having the structure described above, the lights emitted laterally from the LED elements 3 reflect upward, so that light intensity of the central axis of the LED element 3 perpendicular to the aluminum substrate 2 can be enhanced.

Further, also in the eleventh preferred embodiment, the concave portion can be formed at a contact portion of the aluminum substrate 2 to the silicone resin member 5. And, the overcoat member to cover the outside of the phosphor 6 can be also formed. Further, materials of the resin member, light emission wavelengths of the LED element 3, kinds of the phosphor 6 etc. can be appropriately changed.

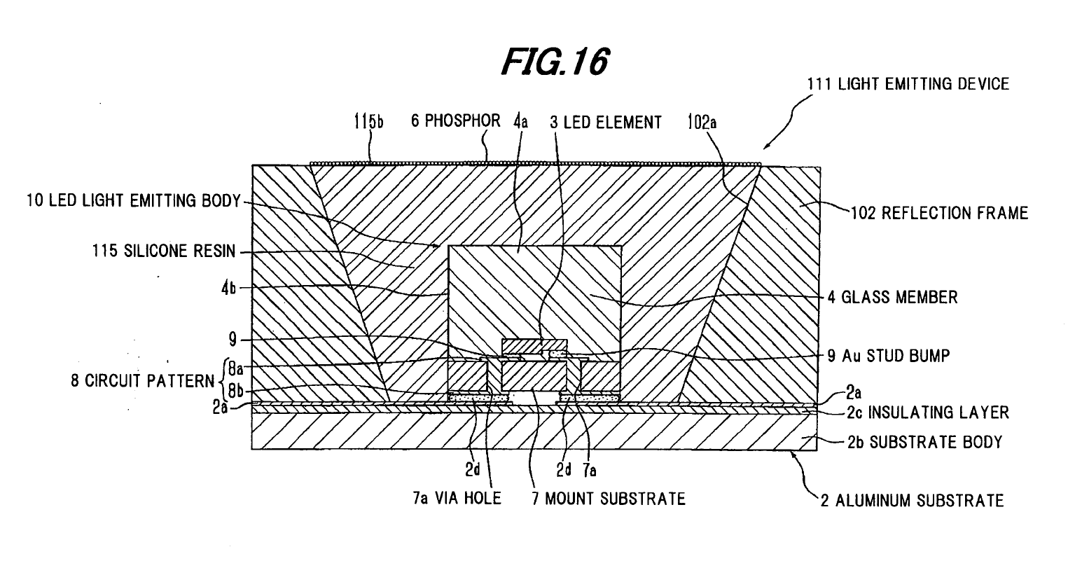

FIG. 16 is a cross sectional view schematically showing a light emitting device in a twelfth preferred embodiment according to the invention. Further, in the explanation of the drawings, the same references are appended to identical or equivalent components, and overlapping explanation is omitted.

As shown in FIG. 16, the light emitting device 111 in the twelfth preferred embodiment is different from the device 101 of the eleventh preferred embodiment in that the inner side of the reflection frame 102 is filled with a silicone resin 115, the phosphor 6 adheres to the upper surface 115b (the surface in a side opposite to the aluminum substrate 2) of the silicone resin 115, and only one LED element 3 is mounted.

According to the light emitting device 111 in the preferred embodiment, even if the inner side of the reflection frame 102 is filled with a silicone resin 115, color heterogeneity of the light taken out can be accurately reduced.

In a conventional device comprising a structure that the inner side of the reflection frame is filled with a resin including a phosphor, unevenness of color is increased due to precipitation of the phosphor dependent on the output angle from the LED element, but in the light emitting device 111 the disadvantage does not occur

Further, also in the twelfth preferred embodiment, the overcoat member to cover the outside of the phosphor 6 can be also formed. Further, materials of the resin member, light emission wavelengths of the LED element 3, kinds of the phosphor 6 etc. can be appropriately changed.

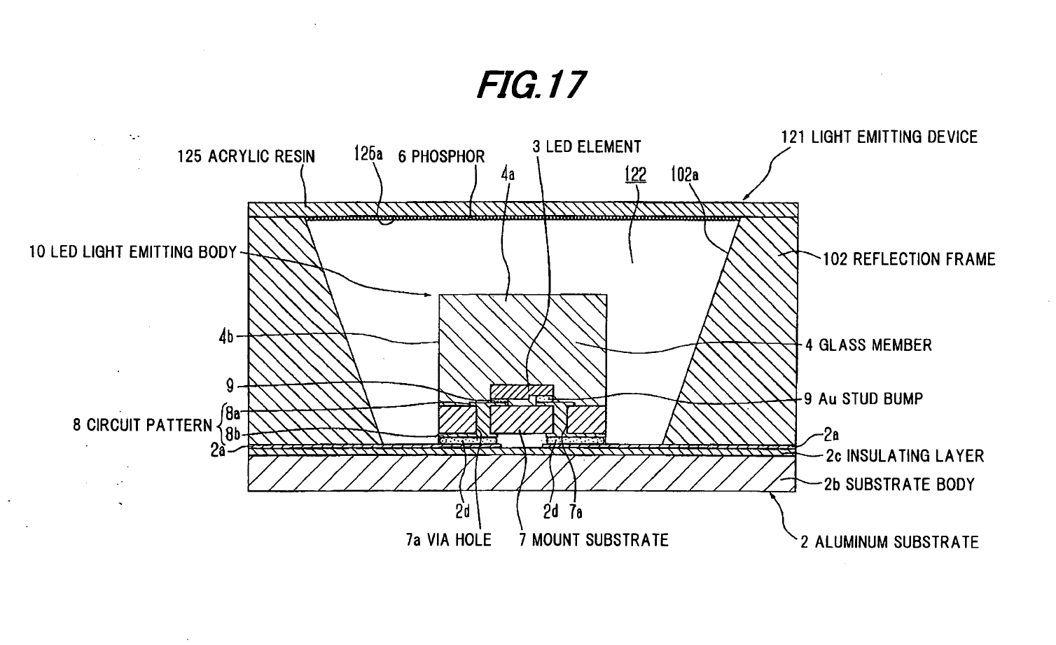

FIG. 17 is a cross sectional view schematically showing a light emitting device in a thirteenth preferred embodiment according to the invention. Further, in the explanation of the drawings, the same references are appended to identical or equivalent components, and overlapping explanation is omitted.

As shown in FIG. 17, the light emitting device 101 in the thirteenth preferred embodiment is different from the device 101 of the eleventh preferred embodiment in that a space 122 is formed inside the reflection frame 102, and the upper end opening of the reflection frame 102 is covered with an acrylic resin 125 comprising a plate-like shape to which the phosphor 6 adheres. In the preferred embodiment, the phosphor 6 adheres to the inner surface 125a (the surface in a side of the aluminum substrate 2) of the acrylic resin 125.

Also, in the light emitting device 121, the phosphor 6 adheres to the inner surface 125a of the acrylic resin 125, so that the phosphor 6 can be effectively protected. And, the phosphor 6 comprises a good adhesiveness to the acrylic resin 125. And, adhesiveness of the acrylic resin 125 is decreased at room temperature, after the making process, foreign substance such as grit and dust may not stick to the acrylic resin 125.

Further, also in the thirteenth preferred embodiment, materials of the resin member, light emission wavelengths of the LED element 3, kinds of the phosphor 6 etc. can be appropriately changed.

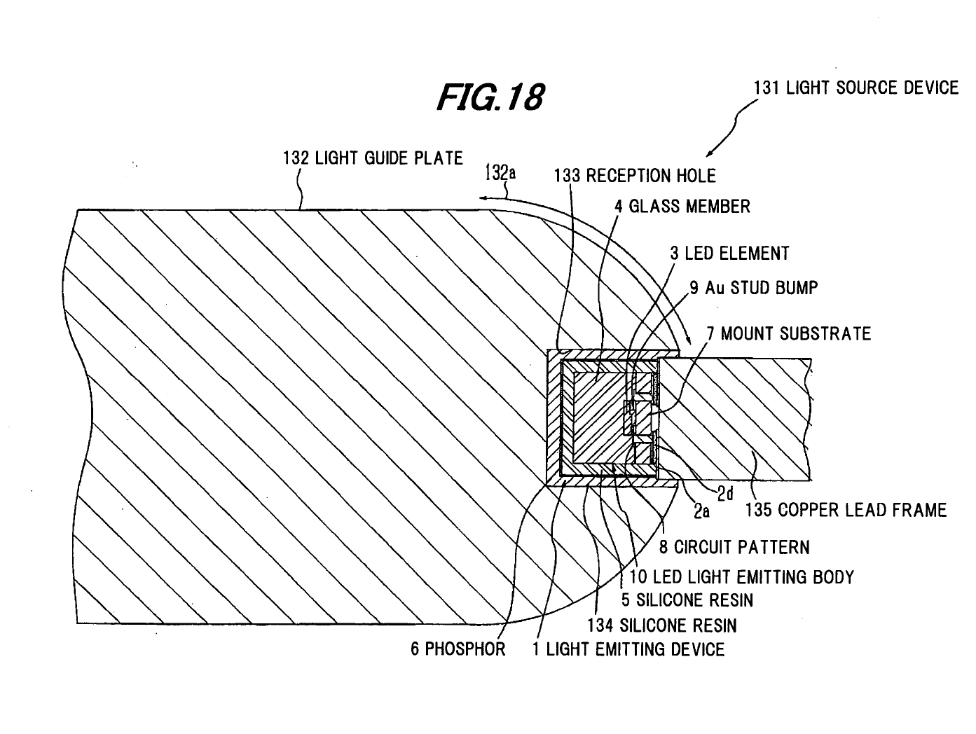

FIG. 18 is a cross sectional view schematically showing a light emitting device in a fourteenth preferred embodiment according to the invention. Further, in the explanation of the drawings, the same references are appended to identical or equivalent components, and overlapping explanation is omitted.

The light source device 131 comprises the light emitting device 1 in the first preferred embodiment comprising a copper lead frame 135 instead of the aluminum substrate 2, and a light guide plate 132 into which the light emitted from the light emitting device 1 enters.

The light guide plate 132 outputs the incident light in a plane shape. In the preferred embodiment, the light guide plate 132 constitutes an optical system to output the incident light emitted from the light emitting device 1 in a certain emission form. The light guide plate 132 comprises a tabular shape extending in a certain direction, and comprises a reflection surface 132a formed with curvature thereon near to the LED light emitting body 10.

The light guide plate 132 comprises a reception hole 133 to receive the light emitting device 1 in the end portion in a longitudinal direction thereof. The reception hole 133 is formed in a rectangular shape slightly larger than the outline of the light emitting device 1.

The reflection surface 132a comprises aluminum deposition so as to achieve a mirror-like finishing.

The reception hole 133 is filled with the silicone resin 134, so as to overcoat the phosphor 6 of the light emitting device 1, and to prevent drastic change of refractive index between the light emitting device 1 and the light guide plate 132.

The light source device 131 can emit a light in a plane shape at the light guide plate 132 by using the light emitting device 1 as a point light source.

Further, in the fourteenth preferred embodiment, the light source device 131 using the light guide plate 132 as an optical system was exemplified, but a light source device having a structure that the light emitting device 1 and other optical system are combined can be also used.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

For example, the light guide plate 132 comprising a structure that the light guide portion and the reflection surface 132a is formed separately and integrated by an adhesive bonding can be also used.

What is claimed is:

1. A light emitting device, comprising:
a light emitting element mounted on a substrate;
a glass member sealing the light emitting element;
a transparent member to transmit light emitted from the light emitting device, the transparent member being positioned outside the glass member, and
a powdery phosphor attached to an inner surface, an outer surface or both of the inner surface and outer surface of the transparent member.

2. The light emitting device according to claim 1, wherein:
the glass member is formed in a rectangular parallelepiped shape, and
the transparent member is close contact with the glass member.

3. The light emitting device according to claim 2, wherein:
the transparent member comprises a resin member, and
the substrate comprises a concave portion formed at a contact portion to the resin member.

4. The light emitting device according to claim 1, wherein:
the glass member is formed in a rectangular parallelepiped shape, and
a space is formed between the glass member and the transparent member.

5. The light emitting device according to claim 1, wherein:
the glass member comprises refractive index of not less than 1.6.

6. The light emitting device according to claim 1, wherein:
the transparent member comprises an adhesive resin member.

7. The light emitting device according to claim 6, wherein:
the resin member comprises adhesiveness at room temperature.

8. The light emitting device according to claim 6, wherein:
the resin member comprises adhesiveness when heated.

9. The light emitting device according to claim 1, wherein:
the transparent member is formed in a lens-like shape to discharge the transmitted light in a predetermined direction.

10. The light emitting device according to claim 1, wherein:
a plurality of the transparent members are sequentially formed in a direction of getting away from the light emitting element, and
the phosphor is attached to each of the plurality of the transparent members.

11. The light emitting device according to claim 1, wherein:
a plurality of the light emitting elements are mounted on the substrate, and
the transparent member surrounds the plurality of the light emitting elements collectively.

12. A light emitting device, comprising:
a light emitting element mounted on a substrate;
a glass member sealing the light emitting element, and
a powdery phosphor attached to an outer surface of the glass member by electrostatic force.

13. A light emitting device, comprising:
a light emitting element mounted on a substrate;
a glass member sealing the light emitting element;
a transparent member to transmit light emitted from the light emitting device, the transparent member being positioned outside the glass member;
a powdery phosphor attached to an inner surface, an outer surface or both of the inner surface and outer surface of the transparent member, and
a reflection frame disposed on the substrate to surround the light emitting element such that light emitted from the light emitting element is reflected in a predetermined direction.

14. The light emitting device according to claim 13, wherein:
the transparent member comprises a resin member filled into an inside of the reflection frame, and
the phosphor is attached to an outer surface of the resin member.

15. The light emitting device according to claim 13, wherein:
the transparent member comprises a plate-like resin member blocking an opening formed by the reflection frame.

16. A light source device, comprising:
the light emitting device according to claim 1, and
an optical system into which light emitted from the light emitting device enters, and which discharges the light in a predetermined emission form.

17. A light source device, comprising:
the light emitting device according to claim 12, and
an optical system into which light emitted from the light emitting device enters, and which discharges the light in a predetermined emission form.

18. A light source device, comprising:
the light emitting device according to claim 13, and
an optical system into which light emitted from the light emitting device enters, and which discharges the light in a predetermined emission form.

19. A method of making a light emitting device, comprising the steps of:
mounting a plurality of light emitting elements on a substrate;
hot-pressing a plate-like glass to the plurality of light emitting elements mounted on the substrate at a predetermined sealing temperature to form a sealed body in which the plurality of light emitting elements are sealed;
segmenting the sealed body into an individual light emitting device, and
attaching a phosphor to a surface of the segmented light emitting device.

20. The method according to claim 19, wherein:
the phosphor attaching step uses the phosphor comprising a lower heat resistance than the predetermined sealing temperature or a melting characteristic at a lower temperature than the predetermined sealing temperature.

21. The method according to claim 19, wherein:
the phosphor attaching step is conducted such that the phosphor is uniformly attached to a resin member coated on the surface of the light emitting device.
